(19) United States
(12) Patent Application Publication
(10) Pub. No.: US 2022/0223894 A1
(43) Pub. Date: Jul. 14, 2022

(54) ELECTROLYTE SHEET FOR SOLID OXIDE FUEL CELLS, METHOD FOR PRODUCING ELECTROLYTE SHEET FOR SOLID OXIDE FUEL CELLS, AND SINGLE CELL FOR SOLID OXIDE FUEL CELLS

(71) Applicant: Murata Manufacturing Co., Ltd., Nagaokakyo-shi (JP)

(72) Inventor: Junji KUROBE, Nagaokakyo-shi (JP)

(21) Appl. No.: 17/705,660

(22) Filed: Mar. 28, 2022

Related U.S. Application Data
(63) Continuation of application No. PCT/JP2020/031092, filed on Aug. 18, 2020.

(30) Foreign Application Priority Data
Oct. 16, 2019 (JP) 2019-189559

(51) Int. Cl. H01M 8/1253; H01M 4/90; H01M 4/88; H01M 8/1213; H01M 8/2425

(52) U.S. Cl. CPC H01M 8/1253; H01M 4/9066; H01M 4/8885; H01M 2008/1293; H01M 4/9025; H01M 8/1213; H01M 8/2425; H01M 4/8896

(57) ABSTRACT

An electrolyte sheet for solid oxide fuel cells that includes: a ceramic plate body having a through hole penetrating therethrough in a thickness direction thereof, wherein a shortest distance between a first point on an outer edge of the ceramic plate body and a second point on a peripheral edge of the through hole is not shorter than 1 mm and not longer than 5 mm, and a warpage height in an area between the first point and the second point is not more than 150 μm.

### CROSS REFERENCE TO RELATED APPLICATIONS

The present application is a continuation of International application No. PCT/JP2020/031092, filed Aug. 18, 2020, which claims priority to Japanese Patent Application No. 2019-189559, filed Oct. 16, 2019, the entire contents of each of which are incorporated herein by reference.

### FIELD OF THE INVENTION

The present invention relates to an electrolyte sheet for solid oxide fuel cells, a method of producing an electrolyte sheet for solid oxide fuel cells, and a unit cell for solid oxide fuel cells.

### BACKGROUND OF THE INVENTION

A solid oxide fuel cell (SOFC) is a device that produces electric energy through reactions of H₂+O²→H₂O+2e⁻ at the fuel electrode and (½)O₂+2e⁻→O²⁻ at the air electrode. A solid oxide fuel cell is a stack of unit cells each including an electrolyte sheet for solid oxide fuel cells made of a ceramic plate body and a fuel electrode and an air electrode that are formed on the electrolyte sheet.

For example, Patent Literature 1 discloses a method of producing a ceramic plate body including forming an unsintered laminate through hole by drilling in an unsintered laminate obtained by alternately stacking unsintered plate bodies and resin sheets or resin layers and compression-bonding the stack.
Patent Literature 1: JP 2018-199256 A

### SUMMARY OF THE INVENTION

As in the production method disclosed in Patent Literature 1, when the stack alternately including the unsintered plate bodies and the resin sheets or resin layers is compression-bonded, the outer edge of each unsintered plate body tends to spread out in directions perpendicular to the stacking direction, i.e., in the surface directions, as compared with the center of the unsintered plate body. The density of the unsintered plate body in the resulting unsintered laminate is therefore not uniform, which may result in variation of heat shrinkage degree inside the unsintered plate body during sintering of the unsintered plate body. Thus, when a ceramic plate body obtained by sintering an unsintered plate body provided with a through hole in the vicinity of the outer edge thereof is used to produce a unit cell, breakages such as cracking or chipping may occur in the vicinity of the through hole. In addition, gas leakage may occur during operations of a fuel cell with such a unit cell. In this respect, the production method disclosed in Patent Literature 1 can still be improved.

The present invention was made to solve the above issues, and aims to provide an electrolyte sheet for solid oxide fuel cells which is capable of preventing breakages such as cracking or chipping during production of a unit cell for solid oxide fuel cells as well as gas leakage during operations of a solid oxide fuel cell with such a unit cell. The present invention also aims to provide a method of producing the electrolyte sheet for solid oxide fuel cells. Furthermore, the present invention aims to provide a unit cell for solid oxide fuel cells which includes the electrolyte sheet for solid oxide fuel cells.

In a first embodiment, the electrolyte sheet for solid oxide fuel cells of the present invention includes: a ceramic plate body having a through hole penetrating therethrough in a thickness direction thereof, wherein a shortest distance between a first point on an outer edge of the ceramic plate body and a second point on a peripheral edge of the through hole is not shorter than 1 mm and not longer than 5 mm, and a warpage height in an area between the first point and the second point is not more than 150 μm.

In a second embodiment, the electrolyte sheet for solid oxide fuel cells of the present invention includes: a ceramic plate body having a through hole penetrating therethrough in a thickness direction thereof, wherein a shortest distance between a first point on an outer edge of the ceramic plate body and a second point on a peripheral edge of the through hole is not less than 0.5% and not more than 10.0% of a distance between the first point and a third point other than the first point among intersection points between the outer edge of the ceramic plate body and a virtual straight line connecting the first point and the second point, and a warpage height in an area between the first point and the second point is not more than 150 μm.

The method of producing an electrolyte sheet for solid oxide fuel cells of the present invention includes: pressing an unpressed body comprising an unsintered plate body containing a ceramic material powder to produce an unsintered body, the unpressed body having a first surface and a second surface opposing each other in a thickness direction of the unpressed body and side surfaces parallel to the thickness direction, the unpressed body being sandwiched between a first metal plate on the first surface and a second metal plate on the second surface and surrounded by a plate frame around the side surfaces thereof such that an elongation of a length of the unsintered body relative to a length of the unpressed body in a direction perpendicular to the thickness direction is within ±1.0%; forming an unsintered body through hole penetrating the unsintered body in the thickness direction; and firing the unsintered body to sinter the unsintered plate body into a ceramic plate body having a through hole penetrating therethrough in the thickness direction.

The unit cell for solid oxide fuel cells of the present invention includes: a fuel electrode; an air electrode; and the electrolyte sheet for solid oxide fuel cells of the present invention between the fuel electrode and the air electrode.

The present invention can provide an electrolyte sheet for solid oxide fuel cells which is capable of preventing breakages such as cracking and chipping during production of a unit cell for solid oxide fuel cells as well as gas leakage during operations of a solid oxide fuel cell with such a unit cell. The present invention can also provide a method of producing the electrolyte sheet for solid oxide fuel cells. Furthermore, the present invention can provide a unit cell for solid oxide fuel cells which includes the electrolyte sheet for solid oxide fuel cells.

### BRIEF DESCRIPTION OF THE DRAWINGS

FIG. 1 is a schematic plan view of an example of an electrolyte sheet for solid oxide fuel cells of the present invention.

FIG. 2 is a schematic cross-sectional view of a portion taken along line A1-A2 in FIG. 1.

FIG. 3 is a schematic plan view of an example of producing ceramic green sheets.

FIG. 4 is another schematic plan view of the example of producing ceramic green sheets.

FIG. 5 is yet another schematic plan view of the example of producing ceramic green sheets.

FIG. 6 is a schematic cross-sectional view of an example of producing an unsintered plate body.

FIG. 7 is a schematic plan view of an example of producing resin layers.

FIG. 8 is another schematic plan view of the example of producing resin layers.

FIG. 9 is yet another schematic plan view of the example of producing resin layers.

FIG. 10 is a schematic cross-sectional view of an example of producing an unpressed body.

FIG. 11 is a schematic perspective view of the unpressed body in FIG. 10.

FIG. 12 is a schematic cross-sectional view of an example of producing an unsintered body.

FIG. 13 is a schematic plan view of the assembly in FIG. 12.

FIG. 14 is another schematic cross-sectional view of the example of producing an unsintered body.

FIG. 15 is yet another schematic cross-sectional view of the example of producing an unsintered body.

FIG. 16 is a schematic cross-sectional view of an example of forming an unsintered body through hole.

FIG. 17 is another schematic cross-sectional view of the example of forming an unsintered body through hole.

FIG. 18 is a schematic cross-sectional view of an example of producing a ceramic plate body.

FIG. 19 is a schematic cross-sectional view of an example of a unit cell for solid oxide fuel cells of the present invention.

### DETAILED DESCRIPTION OF THE PREFERRED EMBODIMENTS

The electrolyte sheet for solid oxide fuel cells (hereinafter, also referred to as the electrolyte sheet) of the present invention, the method of producing an electrolyte sheet for solid oxide fuel cells (hereinafter, also referred to as the method of producing an electrolyte sheet) of the present invention, and the unit cell for solid oxide fuel cells (hereinafter, also referred to as the unit cell) of the present invention are described below. The present invention is not limited to the following preferred embodiments, and may be suitably modified without departing from the gist of the present invention. Combinations of two or more preferred features described in the following preferred features are also within the scope of the present invention.

The drawings are schematic drawings, and the dimensions, the aspect ratio, the scale, and other parameters may differ from those of the actual products.

Electrolyte Sheet for Solid Oxide Fuel Cells

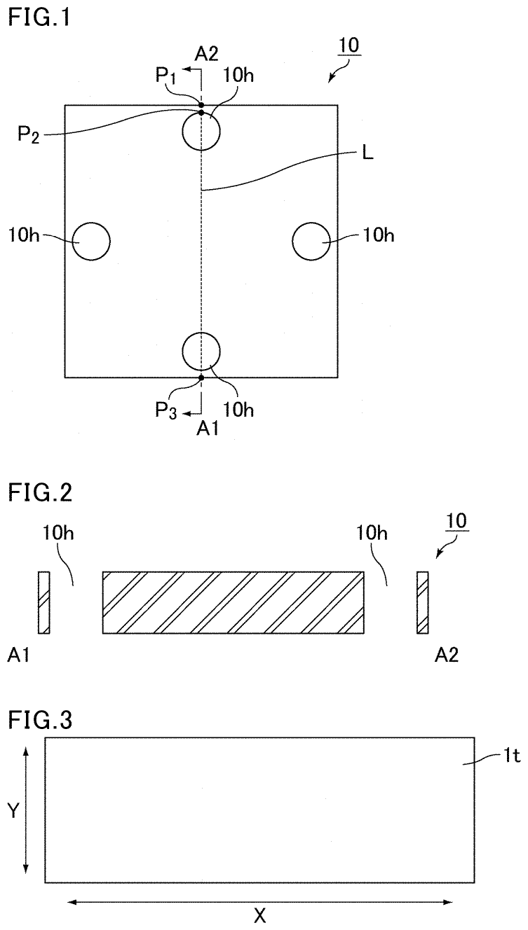

An example of the electrolyte sheet for solid oxide fuel cells of the present invention is described below. FIG. 1 is a schematic plan view of an example of an electrolyte sheet for solid oxide fuel cells of the present invention. FIG. 2 is a schematic cross-sectional view of a portion taken along line A1-A2 in FIG. 1.

An electrolyte sheet 10 for solid oxide fuel cells shown in FIG. 1 and FIG. 2 is made of a ceramic plate body.

The ceramic plate body contains a sintered body of a solid electrolyte such as scandia-stabilized zirconia or yttria-stabilized zirconia. In particular, the electrolyte sheet 10 is preferably made of a ceramic plate body containing sintered scandia-stabilized zirconia. The electrolyte sheet 10, which is made of a ceramic plate body containing sintered scandia-stabilized zirconia, has a higher conductivity. Thus, a solid oxide fuel cell with the electrolyte sheet 10 has a higher power generation efficiency.

In a plan view from a thickness direction of the electrolyte sheet 10 (vertical direction in FIG. 2), the electrolyte sheet 10 has a square shape as shown in FIG. 1, for example.

Although not shown, in a plan view from the thickness direction, the electrolyte sheet 10 preferably has a substantially rectangular shape with rounded corners, more preferably a substantially square shape with rounded corners. In this case, all the corners may be rounded or some of the corners may be rounded.

The electrolyte sheet 10 is provided with through holes 10h penetrating the electrolyte sheet 10 in the thickness direction. The through holes 10h function as gas flow paths in a solid oxide fuel cell.

One through hole 10h may be provided or two or more through holes 10h may be provided. For example, four through holes 10h opposing the centers of the respective four sides of the electrolyte sheet 10 as shown in FIG. 1 may be provided.

In a plan view from the thickness direction, the through holes 10h may have a circular shape as shown in FIG. 1 or any shape other than a circular shape.

Each through hole 10h preferably has a hole diameter of not more than 20 mm. Also, the through hole 10h preferably has a hole diameter of not less than 5 mm. When the through hole 10h has a shape other than a circular shape in a plan view from the thickness direction, the diameter of a circle having an area equivalent to that of the shape above is taken as the hole diameter of the through hole 10h.

In a plan view as in FIG. 1, the size of the electrolyte sheet 10 is, for example, 50 mm×50 mm, 100 mm×100 mm, 110 mm×110 mm, 120 mm×120 mm, or 200 mm×200 mm, for example.

The electrolyte sheet 10 has a thickness of preferably not more than 200 μm, more preferably not more than 130 μm. Also, the electrolyte sheet 10 has a thickness of preferably not less than 30 μm, more preferably not less than 50 μm.

The thickness of the electrolyte sheet 10 is determined as follows. First, the thickness is measured at randomly selected nine sites within a region excluding the portions 5 mm inside the outer edge of the electrolyte sheet 10 with a U-shape Frame Sheet Metal Micrometer (available from Mitutoyo Corporation, PMU-MX). The average of the thicknesses measured at the nine sites is calculated. The average is taken as the thickness of the electrolyte sheet 10.

Preferably, recesses are scattered on a first main surface and a second main surface of the electrolyte sheet 10, although not shown. With the recesses scattered on the first main surface and the second main surface of the electrolyte sheet 10, the area of contact between the electrodes and gas is large in a solid oxide fuel cell with the electrolyte sheet 10. This ultimately increases the power generation efficiency of the solid oxide fuel cell. The recesses may be scattered only on one of the first main surface and the second main surface of the electrolyte sheet 10.

In a first embodiment of the electrolyte sheet 10, with the shortest distance between an outer edge of the electrolyte sheet 10 and the peripheral edge of the through hole 10h being defined as the distance between a first point P₁ on the outer edge of the electrolyte sheet 10 and a second point P₂ on the peripheral edge of the through hole 10h, the shortest distance is not shorter than 1 mm and not longer than 5 mm, and the warpage height in the area between the first point P₁ and the second point P₂ is not more than 150 μm. The present embodiment enables an electrolyte sheet 10 with no or less warpage in the vicinity of the outer edge thereof even when the through hole 10h is provided in the vicinity of the outer edge. The electrolyte sheet 10 is therefore capable of preventing breakages such as cracking or chipping during production of a unit cell for solid oxide fuel cells including the electrolyte sheet 10. The electrolyte sheet 10 is also capable of preventing gas leakage during operations of a solid oxide fuel cell including the electrolyte sheet 10. Thus, the solid oxide fuel cell can exhibit a higher power generation efficiency.

In the first embodiment of the electrolyte sheet 10, the warpage height in the area between the first point P₁ and the second point P₂ is preferably not more than 100 μm. The warpage height may be 0 μm.

In the first embodiment of the electrolyte sheet 10, when a plurality of through holes 10h is provided, at least one through hole 10h should have the features in the first embodiment, and preferably all the through holes 10h have the features in the first embodiment. There may be a through hole 10h failing to have the features in the first embodiment as long as at least one through hole 10h has the features in the first embodiment.

In the second embodiment of the electrolyte sheet 10, with the shortest distance between the outer edge of the electrolyte sheet 10 and the peripheral edge of the through hole 10h being defined as the distance between a first point P₁ on the outer edge of the electrolyte sheet 10 and a second point P₂ on the peripheral edge of the through hole 10h, and with a third point P₃ being defined as any point other than the first point P₁ among intersection points between the outer edge of the ceramic plate body and a virtual straight line connecting the first point P₁ and the second point P₂, the shortest distance is not less than 0.5% and not more than 10.0% of the distance between the first point P₁ and the third point P₃, and the warpage height in the area between the first point P₁ and the second point P₂ is not more than 150 μm. The present embodiment enables an electrolyte sheet 10 with no or less warpage in the vicinity of the outer edge thereof even when the through hole 10h is provided in the vicinity of the outer edge. The electrolyte sheet 10 is therefore capable of preventing breakages such as cracking or chipping during production of a unit cell for solid oxide fuel cells including the electrolyte sheet 10. The electrolyte sheet 10 is also capable of preventing gas leakage during operations of a solid oxide fuel cell including the electrolyte sheet 10. Thus, the solid oxide fuel cell can exhibit a higher power generation efficiency.

In the second embodiment of the electrolyte sheet 10, when the electrolyte sheet 10 has a square shape as shown in FIG. 1 in a plan view from the thickness direction, the distance between the first point P₁ and the third point P₃ corresponds to the length of one side of the square shape.

In the second embodiment of the electrolyte sheet 10, the shortest distance is preferably not shorter than 1 mm and not longer than 5 mm.

In the second embodiment of the electrolyte sheet 10, the warpage height in the area between the first point P₁ and the second point P₂ is preferably not more than 100 μm. The warpage height may be 0 μm.

In the second embodiment of the electrolyte sheet 10, when a plurality of through holes 10h is provided, at least one through hole 10h should have the features in the second embodiment, and preferably all the through holes 10h have the features in the second embodiment. There may be a through hole 10h failing to have the features in the second embodiment as long as at least one through hole 10h has the features in the second embodiment.

In the electrolyte sheet 10, the first point P₁ and the second point P₂ are determined as follows. First, the distance between the outer edge of the electrolyte sheet 10 and the peripheral edge of the through hole 10h is measured with, for example, a video measuring system “NEXIV VMZ-R6555” (available from Nikon Instech Co., Ltd.) to find the shortest distance. Of the two points defining the shortest distance, a point on the outer edge of the electrolyte sheet 10 is defined as the first point P₁ while the other point on the peripheral edge of the through hole 10h is defined as the second point P₂.

In the electrolyte sheet 10, the distance between the first point P₁ and the third point P₃ is measured with, for example, a video measuring system “NEXIV VMZ-R6555” (available from Nikon Instech Co., Ltd.).

On the electrolyte sheet 10, the warpage height in the area between the first point P₁ and the second point P₂ is determined as follows. First, the electrolyte sheet 10 with the warpage as the measurement target is placed to be convex downward. With a wide-area 3D measurement system “VR-5000” available from Keyence Corporation, for example, the difference between the maximum height and the minimum height in the area between the first point P₁ and the second point P₂ is measured. The obtained measurement value is defined as the warpage height.

Method of Producing Electrolyte Sheet for Solid Oxide Fuel Cells

An example of the method of producing an electrolyte sheet for solid oxide fuel cells of the present invention is described below.

Producing Ceramic Green Sheets

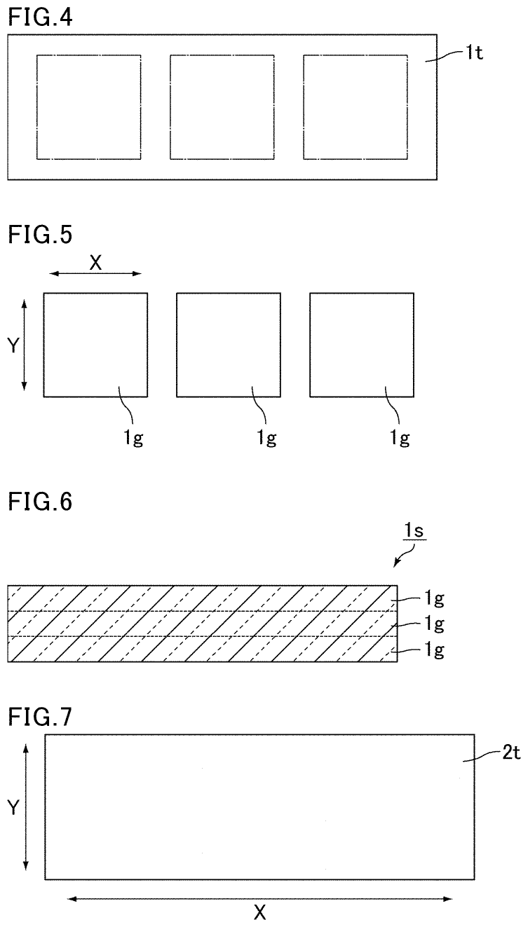

FIG. 3 is a schematic plan view of an example of producing ceramic green sheets. FIG. 4 is another schematic plan view of the example of producing ceramic green sheets. FIG. 5 is yet another schematic plan view of the example of producing ceramic green sheets.

A ceramic material powder, a binder, a dispersant, an organic solvent, and the like are mixed to prepare a ceramic slurry. A first main surface of a carrier film is coated with the obtained ceramic slurry to produce ceramic green tape 1t as shown in FIG. 3.

The ceramic green tape 1t is preferably produced by tape casting, particularly preferably doctor blading or calendaring. In FIG. 3, the casting directions for the tape casting are indicated by X and the directions perpendicular to the casting directions are indicated by Y.

The ceramic material powder may be a solid electrolyte powder such as scandia-stabilized zirconia powder or yttria-stabilized zirconia powder. In particular, the ceramic material powder preferably contains scandia-stabilized zirconia powder.

The resulting ceramic green tape 1t is punched to obtain pieces having a predetermined size by a known technique as shown in FIG. 4, and the carrier film is removed from the pieces. Thus, ceramic green sheets 1g as shown in FIG. 5 are produced. Punching of the ceramic green tape 1t and removal of the carrier film may be performed in any order.

Producing Unsintered Plate Body

FIG. 6 is a schematic cross-sectional view of an example of producing an unsintered plate body.

As shown in FIG. 6, an unsintered plate body 1s is produced by stacking three ceramic green sheets 1g and compression-bonding the stack.

The number of ceramic green sheets 1g used to produce the unsintered plate body 1s may be three as shown in FIG. 6, or two or four or more. The ceramic green sheets 1g may be compression-bonded, or may simply be stacked on one another without being compression-molded. When the unsintered plate body 1s includes a plurality of ceramic green sheets 1g, the thickness of a ceramic plate body to be obtained can be controlled as appropriate in a simple manner.

The unsintered plate body 1s may be produced using one ceramic green sheet 1g. In this case, the step shown in FIG. 6 is omitted.

Producing Resin Layer

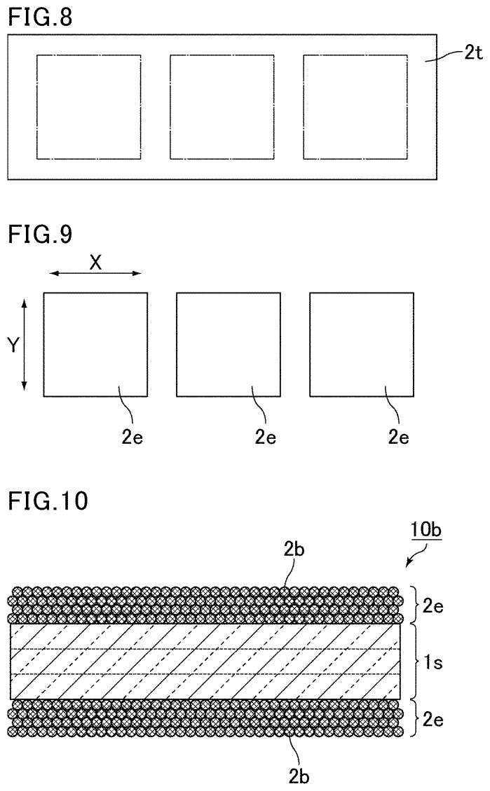

FIG. 7 is a schematic plan view of an example of producing resin layers. FIG. 8 is another schematic plan view of the example of producing resin layers. FIG. 9 is yet another schematic plan view of the example of producing resin layers.

First, a resin powder, a binder, a dispersant, an organic solvent, and the like are mixed to prepare a resin slurry. A first main surface of a carrier film is coated with the obtained resin slurry to produce resin tape 2t as shown in FIG. 7.

The resin tape 2t is preferably produced by tape casting, particularly preferably doctor blading or calendaring. In FIG. 7, the casting directions for the tape casting are indicated by X and the directions perpendicular to the casting directions are indicated by Y.

The resin powder is preferably made of a resin material that is poorly soluble in an organic solvent used in production of a resin slurry. The expression “poorly soluble in an organic solvent” herein means that when 0.1 g of a resin powder and 100 g of an organic solvent are mixed at room temperature (25° C.) for 24 hours, there remains a visually observable residue. The organic solvent used to prepare a resin slurry is, for example, at least one solvent (alone or in a mixture) selected from toluene, ethanol, isopropanol, butyl acetate, ethyl acetate, terpineol, and water. In this case, the resin powder is made of a crosslinked acrylic resin, for example.

Preferably, the resin powder has a spherical shape. When the resin powder has a spherical shape, its median size D₅₀ is, for example, not less than 0.3 μm and not more than 10 μm.

When the resin powder has a spherical shape, the median size D₅₀ of the resin powder is defined as the particle size at 50% in a cumulative particle size distribution curve of the resin powder expressed as cumulative percentage against particle size scale. The particle size distribution of the resin powder is measured with, for example, a laser diffraction particle size distribution measuring device. The median size D₅₀ used here is the equivalent spherical diameter because the resin powder may have a shape distorted through the production processes.

When the resin powder has a spherical shape, the resin powder has a smaller surface area per weight, so that the amount of binder required for preparation of a highly fluid resin slurry is reduced. This makes it possible to produce a resin layer having a high resin powder content, so that many recesses can be formed on a first main surface and a second main surface of a ceramic plate body to be obtained.

Next, the resin tape 2t is punched to obtain pieces having a predetermined size by a known technique as shown in FIG. 8, and the carrier film is removed from the pieces. Thus, resin sheets as resin layers 2e as shown in FIG. 9 are produced. Punching of the resin tape 2t and removal of the carrier film may be performed in any order.

When producing the resin layer 2e, a resin slurry may be applied to one or both of a first main surface and a second main surface of the unsintered plate body 1s instead of producing a resin sheet.

The resin layer 2e has a thickness after drying of not less than 10 μm and not more than 18 μm, for example.

Producing Unpressed Body

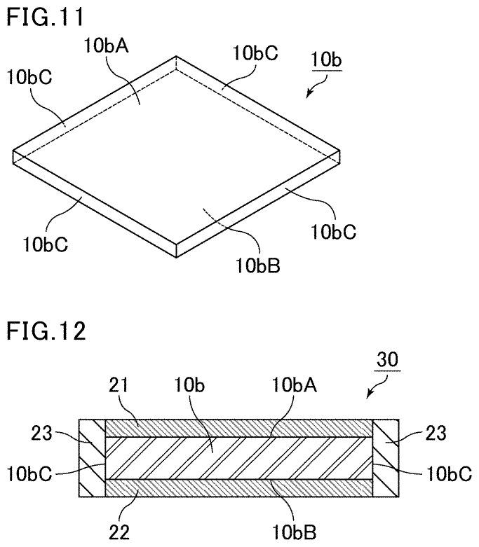

FIG. 10 is a schematic cross-sectional view of an example of producing an unpressed body. FIG. 11 is a schematic perspective view of the unpressed body in FIG. 10.

As shown in FIG. 10, the unsintered plate body 1s containing a ceramic material powder and the resin layers 2e containing a resin powder 2b are stacked in the thickness direction (stacking direction) to produce an unpressed body 10b. More specifically, the resin layer 2e is stacked on each of a first main surface (a top surface in FIG. 10) and a second main surface (a bottom surface in FIG. 10) of the unsintered plate body 1s to produce the unpressed body 10b. In this step, the resin layer 2e may be stacked only on one of the first main surface and the second main surface of the unsintered plate body 1s.

As shown in FIG. 11, the unpressed body 10b has a first surface 10bA and a second surface 10bB opposing each other in the thickness direction and side surfaces 10bC parallel to the thickness direction.

The unpressed body 10b has a thickness of not less than 2 mm and not more than 8 mm, for example.

Producing Unsintered Body

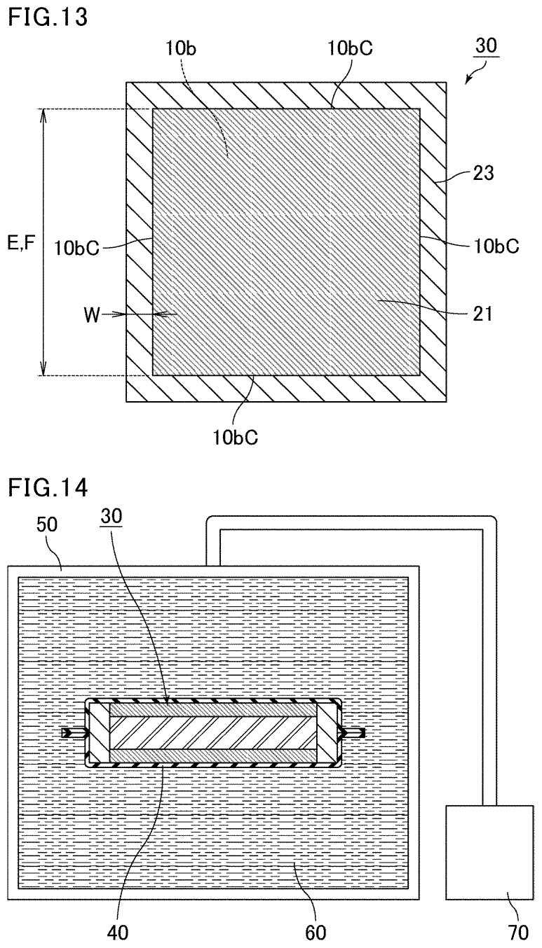

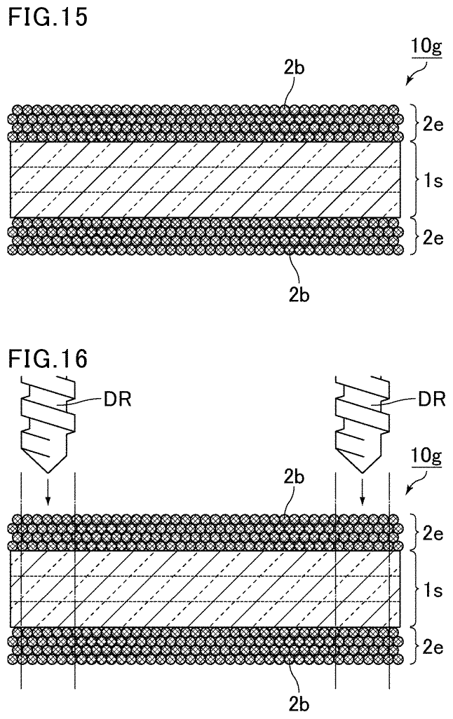

FIG. 12 is a schematic cross-sectional view of an example of producing an unsintered body. FIG. 13 is a schematic plan view of the assembly in FIG. 12. FIG. 14 is another schematic cross-sectional view of the example of producing an unsintered body. FIG. 15 is yet another schematic cross-sectional view of the example of producing an unsintered body.

First, as shown in FIG. 12 and FIG. 13, the unpressed body 10b is sandwiched between a first metal plate 21 on the first surface 10bA and a second metal plate 22 on the second surface 10bB and is surrounded by a plate frame 23 around the side surfaces 10bC, so that an assembly 30 is produced.

In a plan view as shown in FIG. 13, the shape of the first metal plate 21 and the shape of the unpressed body 10b are preferably similar to each other, and the shape of the second metal plate 22 and the shape of the unpressed body 10b are preferably similar to each other.

In a plan view as shown in FIG. 13, the shape of the area surrounded by the inner edge of the plate frame 23 and the shape of the unpressed body 10b are preferably similar to each other.

The first metal plate 21 and the second metal plate 22 may each be made of, for example, a metal such as stainless steel (SUS).

The first metal plate 21 and the second metal plate 22 may be made of the same material or different materials.

The first metal plate 21 and the second metal plate 22 each preferably have a thickness of not more than 3 mm. Also, the first metal plate 21 and the second metal plate 22 each preferably have a thickness of not less than 1 mm.

The first metal plate 21 and the second metal plate 22 may have the same thickness or different thicknesses.

The plate frame 23 may be made of, for example, a plastic material such as a metal or an elastic material such as rubber.

In production of the assembly 30, a resin film made of a resin such as polyethylene terephthalate (PET), for example, is preferably disposed between the unpressed body 10b and the first metal plate 21 and between the unpressed body 10b and the second metal plate 22. The unpressed body 10b easily adheres to the first metal plate 21 and the second metal plate 22. Thus, with a resin film in between them, the assembly 30 is easily disassembled in a subsequent step.

Next, as shown in FIG. 14, the assembly 30 vacuum sealed in the bag 40 is sunk in water 60 in a pressure vessel 50. Subsequently, the water 60 is pressurized by a pump 70. Thus, a predetermined hydrostatic pressure is applied to the unpressed body 10b to press together the unsintered plate body 1s and the resin layers 2e by the hydrostatic pressure.

The bag 40 is made of a material such as a resin, for example.

As described above, an unsintered body 10g is produced in which the unsintered plate body 1s and the resin layers 2e are pressed together as shown in FIG. 15. The assembly 30 is then disassembled to take out the unsintered body 10g.

When the unsintered plate body 1s and the resin layers 2e are pressed together by hydrostatic pressure, the resin layers 2e are pressed onto the first main surface and the second main surface of the unsintered plate body 1s. This forms scattered recesses having a shape derived from the shape of the resin powder 2b on the first main surface and the second main surface of the unsintered plate body 1s.

In production of the unsintered body 10g, the unsintered plate body 1s and the resin layers 2e are pressed together such that an elongation of a length of the unsintered body 10g relative to a length of the unpressed body 10b in a direction perpendicular to the thickness direction, i.e., in a surface direction, is within ±1.0%. This makes the outer edge of the unsintered plate body 1s less apt to spread out. As a result, the variation of density of the unsintered plate body 1s in the unsintered body 10g is prevented or reduced, so that the variation of heat shrinkage degree inside the unsintered plate body 1s is prevented or reduced during the later-described sintering of the unsintered plate body 1s. Thus, when the unsintered plate body 1s is sintered into a ceramic plate body 10p as described later, warpage of the ceramic plate body 10p in the vicinity of the outer edge thereof is prevented or reduced. Breakages such as cracking or chipping can therefore be prevented during production of a unit cell for solid oxide fuel cells including an electrolyte sheet made of such a ceramic plate body 10p. Also, gas leakage can be prevented during operations of a solid oxide fuel cell including the electrolyte sheet made of the ceramic plate body 10p. Thus, the solid oxide fuel cell can exhibit a higher power generation efficiency.

The expression “an elongation of a length of the unsintered body 10g relative to a length of the unpressed body 10b in a direction perpendicular to the thickness direction is within ±1.0%” means that the elongation of a length of the unsintered body 10g relative to a length of the unpressed body 10b in at least one direction perpendicular to the thickness direction is within ±1.0%.

The elongation (unit: %) of a length of the unsintered body 10g relative to a length of the unpressed body 10b is defined by the following formula (M).

Elongation=100×(“length of unsintered body 10g”−“length of unpressed body 10b”)/“length of unpressed body 10b” (M)

The length of the unpressed body 10b and the length of the unsintered body 10g may each be measured with, for example, a video measuring system “NEXIV VMZ-R6555” (available from Nikon Instech Co., Ltd.

A positive elongation means that the unsintered body 10g became longer than the unpressed body 10b in a direction perpendicular to the thickness direction. A negative elongation means that the unsintered body 10g became shorter than the unpressed body 10b in a direction perpendicular to the thickness direction.

In order to control the elongation of the unsintered body 10g to be within ±1.0%, the unpressed body 10b is surrounded by the plate frame 23 around the side surfaces 10bC, so that the plate frame 23 functions as a holding member for the unpressed body 10b, more specifically for the unsintered plate body 1s. Then, the conditions including the material(s) used to produce the plate frame 23, the width of the plate frame 23 in a plan view, and the similarity ratio of the area surrounded by the inner edge of the plate frame 23 to the unpressed body 10b in a plan view are adjusted. The preferred conditions are described below.

The plate frame 23 is preferably made of a metal such as stainless steel.

When made of a metal, the plate frame 23 preferably has a width W of not less than 1 mm in a plan view as shown in FIG. 13. When the plate frame 2 is made of a metal and has a width W of less than 1 mm, the elongation of the unsintered body 10g described above may not be within ±1.0% because the plate frame 23 tends to be significantly deformed during production of the unsintered body 10g.

When made of rubber, the plate frame 23 preferably has a width W of not less than 2 mm in a plan view as shown in FIG. 13. When the plate frame 23 is made of rubber and has a width W of less than 2 mm, the elongation of the unsintered body 10g described above may not be within ±1.0% because the plate frame 23 tends to be significantly deformed during production of the unsintered body 10g.

The width W of the plate frame means the shortest distance between the inner edge and the outer edge of the plate frame.

When the plate frame 23 is made of a metal, the similarity ratio of the area surrounded by the inner edge of the plate frame 23 to the unpressed body 10b in a plan view as shown in FIG. 13 is preferably not less than 1 and not more than 1.02, particularly preferably 1. In FIG. 13, the similarity ratio of the area surrounded by the inner edge of the plate frame 23 to the unpressed body 10b is 1, i.e., there is no gap between the unpressed body 10b and the plate frame 23. When the similarity ratio of the area surrounded by the inner edge of the plate frame 23 to the unpressed body 10b is more than 1, there is a gap between the unpressed body 10b and the plate frame 23. When the plate frame 23 is made of a metal and the similarity ratio of the area surrounded by the inner edge of the plate frame 23 to the unpressed body 10b is more than 1.02, there is a large gap between the unpressed body 10b and the plate frame 23, and thus the elongation of the unsintered body 10g may not be within ±1.0%.

When the plate frame 23 is made of rubber, the similarity ratio of the area surrounded by the inner edge of the plate frame 23 to the unpressed body 10b in a plan view as shown in FIG. 13 is preferably not less than 1 and not more than 1.02, particularly preferably 1. When the plate frame 23 is made of rubber and the similarity ratio of the area surrounded by the inner edge of the plate frame 23 to the unpressed body 10b is more than 1.02, there is a large gap between the unpressed body 10b and the plate frame 23, and thus the elongation of the unsintered body 10g may not be within ±1.0%.

Specifically, as for the similarity ratio, the ratio of the inside dimension F of the plate frame 23 to the length E of the unpressed body 10b as shown in FIG. 13 is preferably not less than 100% and not more than 102%, particularly preferably 100%. FIG. 13 shows the case where the length E of the unpressed body 10b and the inside dimension F of the plate frame 23 are the same as each other.

The first metal plate 21 and the second metal plate 22 preferably have the same size as the area surrounded by the inner edge of the plate frame 23 in a plan view. In other words, in a plan view as shown in FIG. 13, the similarity ratio of the first metal plate 21 to the unpressed body 10b and the similarity ratio of the second metal plate 22 to the unpressed body 10b are each preferably not less than 1 and not more than 1.02, particularly preferably 1.

In the present step, hydrostatic pressure is used as the pressurization method, which applies uniform pressure to the unpressed body 10b, more specifically to the unsintered plate body 1s. Thus, use of hydrostatic pressure as the pressurization method contributes to prevention or reduction of variation of density of the unsintered plate body 1s. In this viewpoint, hydrostatic pressure is preferably used as the pressurization method. Although the present step employs hydrostatic pressure as the pressurization method, pressurization may be performed by any other method.

The unsintered body 10g may be cut into a shape back-calculated from a possible heat shrinkage rate of the unsintered plate body 1s during firing of the unsintered body 10g (described later) and the desired shape of a ceramic plate body 10p to be obtained.

Forming Unsintered Body Through Hole

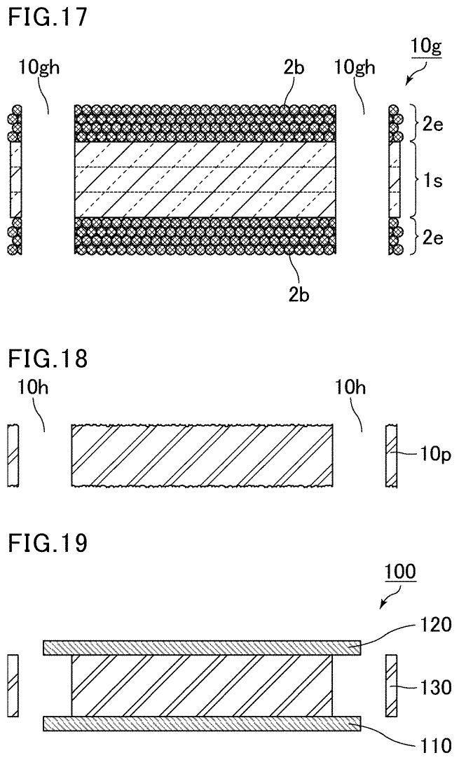

FIG. 16 is a schematic cross-sectional view of an example of forming an unsintered body through hole. FIG. 17 is another schematic cross-sectional view of the example of forming an unsintered body through hole.

As shown in FIG. 16 and FIG. 17, unsintered body through holes 10gh penetrating the unsintered body 10g in a thickness direction thereof are formed.

The unsintered body through holes 10gh are preferably formed with at least one drill DR. In this case, the unsintered body 10g is drilled with the drill DR from its first main surface to its second main surface or vice versa such that the unsintered body through holes 10gh penetrating the unsintered body 10g in the thickness direction are formed. The drilling with the drill DR may be performed under any conditions.

Only one unsintered body through hole 10gh may be formed or two or more unsintered body through holes 10gh may be formed.

Producing Ceramic Plate Body

FIG. 18 is a schematic cross-sectional view of an example of producing a ceramic plate body.

The unsintered body 10g is fired to burn off the resin layers 2e and sinter the unsintered plate body 1s into a ceramic plate body 10p provided with through holes 10h penetrating the ceramic plate body 10p in the thickness direction as shown in FIG. 18.

As described above, the variation of density of the unsintered plate body 1s is prevented or reduced during firing the unsintered body 10g, so that the variation of heat shrinkage degree inside the unsintered plate body 1s is prevented or reduced. Thus, warpage of a ceramic plate body 10p to be obtained is prevented or reduced in the vicinity of the outer edge thereof.

Preferably, the firing the unsintered body 10g includes degreasing and sintering.

Thus, the ceramic plate body 10p is produced which is provided with the through holes 10h penetrating the ceramic plate body 10p in the thickness direction.

In the producing of the unsintered body in the method of producing an electrolyte sheet, the unsintered plate body 1s and the resin layers 2e are pressed together in a state where the unpressed body 10b is sandwiched between the first metal plate 21 on the first surface 10bA and the second metal plate 22 on the second surface 10bB and is surrounded by the plate frame 23 around the side surfaces 10bC, such that an elongation of a length of the unsintered body 10g relative to a length of the unpressed body 10b in a direction perpendicular to the thickness direction is within ±1.0%.

Thus, in the ceramic plate body 10p provided with the through holes 10h, as described above with reference to FIG. 1, the distance between the first point P₁ and the second point P₂ is not shorter than 1 mm and not longer than 5 mm, and the warpage height in the area between the first point P₁ and the second point P₂ is not more than 150 μm. In other words, the method of producing an electrolyte sheet described above enables the first embodiment of the electrolyte sheet for solid oxide fuel cells of the present invention which is made of the ceramic plate body 10p (for example, the electrolyte sheet 10 in FIG. 1 and FIG. 2).

Also, in the ceramic plate body 10p provided with the through holes 10h, as described above with reference to FIG. 1, the distance between the first point P₁ and the second point P₂ is not less than 0.5% and not more than 10.0% of the distance between the first point P₁ and the third point P₃, and the warpage height in the area between the first point P₁ and the second point P₂ is not more than 150 μm. In other words, the method of producing an electrolyte sheet described above enables the second embodiment of the electrolyte sheet for solid oxide fuel cells of the present invention which is made of the ceramic plate body 10p (for example, the electrolyte sheet 10 shown in FIG. 1 and FIG. 2).

In the method of producing an electrolyte sheet above, the ceramic plate body 10p is produced which is provided with scattered recesses on the first main surface and the second main surface. In the method of producing an electrolyte sheet above, the resin layers 2e were used to form such recesses. Yet, recesses may be formed on the first main surface and the second main surface of the unsintered plate body with a stamper in advance before sintering of the unsintered plate body. In this case, an unpressed body is produced using the unsintered plate body provided with recesses in the producing an unpressed body, an unsintered body is produced by pressing the unsintered plate body through pressing of the unpressed body, preferably by hydrostatic press, in the producing an unsintered body, and a ceramic plate body is produced through firing the unsintered body to sinter the unsintered plate body in the producing a ceramic plate body.

Unit Cell for Solid Oxide Fuel Cells

The following describes an example of the unit cell for solid oxide fuel cells of the present invention. FIG. 19 is a schematic cross-sectional view of an example of the unit cell for solid oxide fuel cells of the present invention.

As shown in FIG. 19, a unit cell 100 for solid oxide fuel cells includes a fuel electrode 110, an air electrode 120, and an electrolyte sheet 130. The electrolyte sheet 130 is disposed between the fuel electrode 110 and the air electrode 120.

The fuel electrode 110 may be a known fuel electrode for solid oxide fuel cells.

The air electrode 120 may be a known air electrode for solid oxide fuel cells.

The electrolyte sheet 130 is the electrolyte sheet for solid oxide fuel cells of the present invention (for example, the electrolyte sheet 10 in FIG. 1 and FIG. 2). Thus, the unit cell 100 is capable of increasing the power generation efficiency of a solid oxide fuel cell with the unit cell.

Method of Producing Unit Cell for Solid Oxide Fuel Cells

The unit cell for solid oxide fuel cells of the present invention is produced by the following method, for example.

First, a slurry for a fuel electrode and a slurry for an air electrode are prepared. The slurry for a fuel electrode is prepared by mixing a powder of a material of a fuel electrode with a binder, a dispersant, a solvent, and the like as appropriate. The slurry for an air electrode is prepared by mixing a powder of a material of an air electrode with a binder, a dispersant, a solvent, and the like as appropriate.

The material of a fuel electrode may be a known material of a fuel electrode for solid oxide fuel cells.

The material of an air electrode may be a known material of an air electrode for solid oxide fuel cells.

The binder, dispersant, solvent, and other additives in a slurry for a fuel electrode may be those known in a method of forming a fuel electrode for solid oxide fuel cells. The binder, dispersant, solvent, and other additives in a slurry for an air electrode may be those known in a method of forming an air electrode for solid oxide fuel cells.

Then, a first main surface of the electrolyte sheet is coated with the slurry for a fuel electrode to a predetermined thickness and a second main surface of the electrolyte sheet is coated with the slurry for an air electrode to a predetermined thickness. These coating films are dried to form a green layer for a fuel electrode and a green layer for an air electrode.

The green layer for a fuel electrode and the green layer for an air electrode are then fired to form a fuel electrode and an air electrode. The firing conditions such as the firing temperature may be determined as appropriate depending on the material and the like of the fuel electrode or the air electrode.

### EXAMPLES

Examples that more specifically disclose the electrolyte sheet for solid oxide fuel cells of the present invention are described below. The present invention is not limited to these examples.

### Example 1

An electrolyte sheet of Example 1 was produced by the following method.

Producing Ceramic Green Sheets

Scandia-stabilized zirconia powder, a binder, a dispersant, and an organic solvent were compounded at a predetermined ratio. The organic solvent used was a 7:3 mixture by weight of toluene and ethanol. The compounded product was stirred with a medium made of partially stabilized zirconia at 1000 rpm for three hours to form a ceramic slurry.

Then, the ceramic slurry was formed into a sheet on a first main surface of a carrier film made of polyethylene terephthalate by a known technique of tape casting to give ceramic green tape.

The ceramic green tape was then punched by a known technique into pieces having a 100-mm-square shape in a plan view thereof after the firing, and the carrier film was removed from the pieces. Thus, ceramic green sheets were produced.

Producing Unsintered Plate Body

Three ceramic green sheets were stacked and compression-bonded to produce an unsintered plate body.

Producing Resin Layer

First, a resin powder, a binder, a dispersant, and an organic solvent were compounded at a predetermined ratio. The resin powder used was a spherical resin powder made of a crosslinked acrylic resin and having a median size D₅₀ of 0.3 μm. The organic solvent used was a 7:3 mixture by weight of toluene and ethanol. The compounded product was stirred with a medium made of partially stabilized zirconia at 1000 rpm for three hours to prepare a resin slurry.

Then, the resin slurry was formed into a sheet on a first main surface of a carrier film made of polyethylene terephthalate by a known technique of tape casting to give resin tape.

The resin tape was then punched by a known technique into pieces having the same size as the ceramic green sheets in a plan view, and the carrier film was removed from the pieces. Thus, resin sheets as resin layers were produced. Each resin sheet had a thickness after drying of not less than 10 μm and not more than 18 μm.

Producing Unpressed Body

The unsintered plate body and the resin sheets were stacked in the thickness direction (stacking direction) to produce an unpressed body. Here, the unpressed body had a first surface and a second surface opposing each other in the thickness direction and side surfaces parallel to the thickness direction. More specifically, the resin sheet was stacked on each of the first main surface and the second main surface of the unsintered plate body to produce an unpressed body. Thus, the resin sheet was disposed on each of the first surface of the unpressed body and the second surface of the unpressed body. In this step, 100 such unpressed bodies were produced.

Producing Unsintered Body

First, each of the 100 unpressed bodies was sandwiched between a first metal plate on the first surface and a second metal plate on the second surface and was surrounded by a plate frame around the side surfaces such that an assembly was produced. In a plan view thereof, the area surrounded by the inner edge of the plate frame and the unpressed body were both square-shaped and similar to each other. In production of the assembly, a polyethylene terephthalate film was disposed between the unpressed body and the first metal plate and between the unpressed body and the second metal plate.

The first metal plate and the second metal plate were each made of a stainless steel plate. The first metal plate and the second metal plate each had a thickness of 2 mm. The first metal plate and the second metal plate had the same size as the unpressed body in a plan view. In other words, in a plan view, the similarity ratio of the first metal plate to the unpressed body was 1, and the similarity ratio of the second metal plate to the unpressed body was 1.

The plate frame used was a stainless steel plate frame. In a plan view, the plate frame had a width of 2 mm. Th area surrounded by the inner edge of the plate frame had the same size as the unpressed body in a plan view, i.e., the same size as the first metal plate and the second metal plate in a plan view. In other words, in a plan view, the similarity ratio of the area surrounded by the inner edge of the plate frame to the unpressed body was 1.

Next, the assembly vacuum sealed in a plastic bag was sunk in water at 60° C. in a pressure vessel. Subsequently, the water was pressurized by a pump to apply a hydrostatic pressure of 1500 kgf/cm² (150 MPa) to the unpressed body, whereby the unsintered plate body and the resin layers were pressed together by hydrostatic pressure. The pressurization temperature was 60° C.

As described above, an unsintered body was produced in which the unsintered plate body and the resin layers were pressed together. Then, the assembly was disassembled to take out the unsintered body.

In the present step, the above procedure was performed on each of the 100 unpressed bodies, so that 100 unsintered bodies were produced. In other words, in the present step, the cycle of producing one unsintered body from one unpressed body was repeated 100 times.

Forming Unsintered Body Through Hole

In each of the 100 unsintered bodies, four unsintered body through holes penetrating the unsintered body in the thickness direction thereof were formed by drilling. The drilling was performed at a feed rate of 0.04 mm/revolution and a spindle speed of 2000 revolutions/minute. The unsintered body through holes were formed such that the through holes would oppose the centers of the respective four sides of the unsintered plate body and, in the ceramic plate body to be obtained by firing the unsintered body, the shortest distance between the outer edge of the ceramic plate body and the peripheral edge of each through hole would be 3 mm. Each unsintered body through hole had a hole diameter after the firing of 15 mm.

Producing Ceramic Plate Body

Each of the 100 unsintered bodies was fired in a furnace as follows. First, the unsintered body was degreased by holding the unsintered body at 400° C. for a predetermined time. The degreased unsintered body was sintered by holding the unsintered body at 1400° C. for five hours. As described above, the unsintered body was fired to burn off the resin layers and sinter the unsintered plate body into a ceramic plate body provided with four through holes penetrating the ceramic plate body in the thickness direction. In this step, each of the 100 unsintered bodies was fired, so that 100 ceramic plate bodies were produced.

Each ceramic plate body had a 100-mm-square shape in a plan view thereof and a thickness of 90 μm. The four through holes in each ceramic plate body were each formed at a position where the through hole opposes the center of the corresponding side among the four sides of the ceramic plate body. In each ceramic plate body, the shortest distance between the outer edge of the ceramic plate body and the peripheral edge of each of the four through holes was 3 mm. In other words, the shortest distance was 3% of the length of one side of the ceramic plate body. Each through hole had a hole diameter of 15 mm.

Thus, 100 electrolyte sheets (ceramic plate bodies) of Example 1 were produced.

### Example 2

One hundred electrolyte sheets of Example 2 were produced as in Example 1, except that the conditions of the producing an unsintered body were changed to the following conditions.

In a plan view, the similarity ratio of the first metal plate to the unpressed body was 1.01.

In a plan view, the similarity ratio of the second metal plate to the unpressed body was 1.01.

In a plan view, the similarity ratio of the area surrounded by the inner edge of the plate frame to the unpressed body was 1.01.

### Example 3

One hundred electrolyte sheets of Example 3 were produced as in Example 1, except that the conditions of the producing an unsintered body were changed to the following conditions.

The plate frame used was one made of natural rubber.

### Example 4

One hundred electrolyte sheets of Example 4 were produced as in Example 1, except that the conditions of the producing an unsintered body were changed to the following conditions.

The plate frame used was one made of natural rubber.

In a plan view, the plate frame had a width of 3 mm.

### Comparative Example 1

One hundred electrolyte sheets of Comparative Example 1 were produced as in Example 1, except that the conditions of the producing an unsintered body were changed to the following conditions.

In a plan view, the similarity ratio of the first metal plate to the unpressed body was 1.03.

In a plan view, the similarity ratio of the second metal plate to the unpressed body was 1.03.

In a plan view, the similarity ratio of the area surrounded by the inner edge of the plate frame to the unpressed body was 1.03.

### Comparative Example 2

One hundred electrolyte sheets of Comparative Example 2 were produced as in Example 1, except that the conditions of the producing an unsintered body were changed to the following conditions.

The plate frame used was one made of natural rubber.

In a plan view, the plate frame had a width of 1 mm.

Evaluations

The electrolyte sheets of Examples 1 to 4 and Comparative Examples 1 and 2 were subjected to the following evaluations.

Elongation of Unsintered Body

In the producing an unsintered body, in each of the 100 cycles above, the length of the unpressed body and the length of the unsintered body in a direction perpendicular to the thickness direction were measured with a video measuring system “NEXIV VMZ-R6555” (available from Nikon Instech Co., Ltd.). Here, for the length of the unpressed body and the length of the unsintered body, the length of a specific side of a square shape in a plan view before pressurization and the length of the specific side of the square shape in the plan view after the pressurization were selected. The elongation of the unsintered body relative to the unpressed body in each of the 100 cycles was calculated from the formula (M) above. Table 1 shows the calculated elongations and the average of the elongations in each cycle.

Warpage Height

On each of the 100 electrolyte sheets, the warpage height in the area between the first point P₁ and the second point P₂ was measured for each of the four through holes by the method described above with reference to FIG. 1, with a wide-area 3D measurement system “VR-5000” available from Keyence Corporation. Table 1 shows the measured warpage heights at the respective sites and the average of the warpage heights.

Cracking and Chipping of Electrolyte Sheet in Unit Cell

First, a fuel electrode slurry containing nickel oxide powder and scandia-stabilized zirconia powder was prepared. Next, a first main surface of each electrolyte sheet was coated with the fuel electrode slurry by screen printing. The coating film of the fuel electrode slurry was dried to form a fuel electrode green layer. The fuel electrode green layer was then fired at 1300° C., so that a fuel electrode was formed. The fuel electrode had a thickness of 30 μm.

An air electrode slurry containing lanthanum strontium cobalt ferrite (LSCF) powder was prepared. Next, a gadolinia-doped ceria (GDC) layer as a barrier layer was formed on a second main surface of the electrolyte sheet, followed by coating of the barrier layer with the air electrode slurry by screen printing. The barrier layer had a thickness of 10 μm. The coating film of the air electrode slurry was dried to form an air electrode green layer. The air electrode green layer was then fired at 1000° C., so that an air electrode was formed. The air electrode had a thickness of 30 μm.

As described above, 100 unit cells were produced from the 100 electrolyte sheets. All the unit cells were visually checked for cracking and/or chipping of the electrolyte sheet in the vicinity of the outer edge thereof, and the number of cracked and/or chipped electrolyte sheets was counted. Table 1 shows the results.

Gas Leakage from Cell Stack

A separator made of a ferrite-based alloy material and provided with a channel was coated with three pastes as follows. The three pastes were: a glass-based sealing paste; a first conductive paste that originally mainly contains nickel oxide and mainly contains nickel after the reduction reaction; and a second conductive paste that contains a conductive oxide such as lanthanum strontium manganite (LSM). The peripheral edge of each main surface of the separator was coated with the glass-based sealing paste. The central area of the main surface of the separator in contact with the fuel electrode was coated with the first conductive paste. The central area of the main surface of the separator in contact with the air electrode was coated with the second conductive paste. Thus, 120 separators coated with the three pasts were produced.

Next, one cell stack was produced by alternately stacking six separators out of the 120 separators and five unit cells out of the 100 unit cells, so that 20 cell stacks were produced. In production of each cell stack, the separators and the unit cells were bonded to each other by applying a weight of about 5 kg and heat-processing the stack at 900° C.

Then, air was supplied to the 20 cell stacks at a pressure of 0.1 kgf/cm² (0.01 MPa) to evaluate air leakage. Specifically, an air supply amount of more than 5 cc/min used to maintain the air supply pressure (0.1 kgf/cm²) was regarded as indicating significant air leakage, and the number of cell stacks with such an air supply amount was counted. Table 1 shows the results.

TABLE 1

| | | | | | | Comparative | Comparative |
|---|---|---|---|---|---|---|---|
| | | Example 1 | Example 2 | Example 3 | Example 4 | Example 1 | Example 2 |
| Elongation of | Each cycle | Within ±1.0 | Within ±1.0 | Within ±1.0 | Within ±1.0 | Over ±1.0 | Over ±1.0 |
| unsintered body (%) | Average | 0.0 | 1.0 | −1.0 | −0.5 | 1.8 | −2.0 |
| Warpage height (μm) | Each site | ≤150 | ≤150 | ≤150 | ≤150 | >150 | >150 |
| | Average | 10 | 70 | 25 | 95 | 180 | 360 |
| Cracking/chipping | Chipping | 0 | 0 | 0 | 0 | 2 | 3 |
| of electrolyte sheet | Cracking | 0 | 0 | 0 | 0 | 4 | 5 |
| in unit cell (number | | | | | | | |
| of electrolyte sheets) | | | | | | | |

| | | | | | | |
|---|---|---|---|---|---|---|
| Gas leakage from cell stack | 0 | 0 | 0 | 0 | 2 | 4 |
| (number of cell stacks) | | | | | | |

As shown in Table 1, the electrolyte sheets of Examples 1 to 4 had an elongation of the unsintered body of within ±1.0% in the producing an unsintered body, and thus had no or less warpage in the vicinity of the outer edge thereof. The electrolyte sheets of Examples 1 to 4 therefore caused no cracking or chipping when incorporated in a unit cell, and caused no gas leakage when incorporated in a cell stack.

As shown in Table 1, the electrolyte sheets of Comparative Examples 1 and 2 had an elongation of the unsintered body over ±1.0% in the producing an unsintered body, and thus caused warpage in the vicinity of the outer edge thereof. The electrolyte sheets of Comparative Examples 1 and 2 therefore caused cracking and/or chipping when incorporated in a unit cell and caused gas leakage when incorporated in a cell stack.

### REFERENCE SIGNS LIST

1g ceramic green sheet
1s unsintered plate body
1t ceramic green tape
2b resin powder
2e resin layer
2t resin tape
10, 130 electrolyte sheet for solid oxide fuel cells (electrolyte sheet)
10b unpressed body
10bA first surface of unpressed body
10bB second surface of unpressed body
10bC side surface of unpressed body
10g unsintered body
10gh unsintered body through hole
10h through hole
10p ceramic plate body
21 first metal plate
22 second metal plate
23 plate frame
30 assembly
40 bag
50 pressure vessel
60 water
70 pump
100 unit cell for solid oxide fuel cells (unit cell)
110 fuel electrode
120 air electrode
DR drill
E length of unpressed body
F inside dimension of plate frame
L virtual straight line
P₁ first point
P₂ second point
P₃ third point
W width of plate frame
X casting directions
Y directions perpendicular to casting directions

1. An electrolyte sheet for solid oxide fuel cells, the electrolyte sheet comprising:
a ceramic plate body having a through hole penetrating therethrough in a thickness direction thereof,
wherein a shortest distance between a first point on an outer edge of the ceramic plate body and a second point on a peripheral edge of the through hole is not shorter than 1 mm and not longer than 5 mm, and
a warpage height in an area between the first point and the second point is not more than 150 μm.

2. The electrolyte sheet for solid oxide fuel cells according to claim 1, wherein the ceramic plate body comprises sintered scandia-stabilized zirconia.

3. The electrolyte sheet for solid oxide fuel cells according to claim 1, wherein the warpage height is not more than 100 μm.

4. A unit cell for solid oxide fuel cells, the unit cell comprising:
a fuel electrode;
an air electrode; and
the electrolyte sheet for solid oxide fuel cells according to claim 1 between the fuel electrode and the air electrode.

5. An electrolyte sheet for solid oxide fuel cells, the electrolyte sheet comprising:
a ceramic plate body having a through hole penetrating therethrough in a thickness direction thereof,
wherein a shortest distance between a first point on an outer edge of the ceramic plate body and a second point on a peripheral edge of the through hole is not less than 0.5% and not more than 10.0% of a distance between the first point and a third point other than the first point among intersection points between the outer edge of the ceramic plate body and a virtual straight line connecting the first point and the second point, and
a warpage height in an area between the first point and the second point is not more than 150 μm.

6. The electrolyte sheet for solid oxide fuel cells according to claim 5, wherein the ceramic plate body comprises sintered scandia-stabilized zirconia.

7. The electrolyte sheet for solid oxide fuel cells according to claim 5, wherein the shortest distance is not shorter than 1 mm and not longer than 5 mm.

8. The electrolyte sheet for solid oxide fuel cells according to claim 5, wherein the warpage height is not more than 100 μm.

9. A unit cell for solid oxide fuel cells, the unit cell comprising:
a fuel electrode;
an air electrode; and
the electrolyte sheet for solid oxide fuel cells according to claim 5 between the fuel electrode and the air electrode.

10. A method of producing an electrolyte sheet for solid oxide fuel cells, the method comprising:
pressing an unpressed body comprising an unsintered plate body containing a ceramic material powder to produce an unsintered body, the unpressed body having a first surface and a second surface opposing each other in a thickness direction of the unpressed body and side surfaces parallel to the thickness direction, the unpressed body being sandwiched between a first metal plate on the first surface and a second metal plate on the second surface and surrounded by a plate frame around the side surfaces thereof such that an elongation of a length of the unsintered body relative to a length of the unpressed body in a direction perpendicular to the thickness direction is within ±1.0%;
forming an unsintered body through hole penetrating the unsintered body in the thickness direction; and
firing the unsintered body to sinter the unsintered plate body into a ceramic plate body having a through hole penetrating therethrough in the thickness direction.

11. The method of producing an electrolyte sheet for solid oxide fuel cells according to claim 10, wherein the plate frame is made of a metal.

12. The method of producing an electrolyte sheet for solid oxide fuel cells according to claim 10, wherein the unsintered plate body is pressed by hydrostatic pressure.

13. The method of producing an electrolyte sheet for solid oxide fuel cells according to claim 10,
wherein the unpressed body includes the unsintered plate body and a resin layer containing a resin powder stacked in the thickness direction,
in the pressing of the unpressed body, the unsintered plate body and the resin layer are pressed together, and
in the firing of the unsintered body, the unsintered body is fired at a temperature to burn off the resin layer and sinter the unsintered plate body into the ceramic plate body.

14. The method of producing an electrolyte sheet for solid oxide fuel cells according to claim 10, wherein the ceramic material powder contains scandia-stabilized zirconia powder.

15. The method of producing an electrolyte sheet for solid oxide fuel cells according to claim 10, wherein
a shortest distance between a first point on an outer edge of the ceramic plate body and a second point on a peripheral edge of the through hole is not shorter than 1 mm and not longer than 5 mm, and
a warpage height in an area between the first point and the second point is not more than 150 μm.

16. The method of producing an electrolyte sheet for solid oxide fuel cells according to claim 15, wherein the warpage height is not more than 100 μm.

17. The method of producing an electrolyte sheet for solid oxide fuel cells according to claim 10, wherein
a shortest distance between a first point on an outer edge of the ceramic plate body and a second point on a peripheral edge of the through hole is not less than 0.5% and not more than 10.0% of a distance between the first point and a third point other than the first point among intersection points between the outer edge of the ceramic plate body and a virtual straight line connecting the first point and the second point, and
a warpage height in an area between the first point and the second point is not more than 150 μm.

18. The method of producing an electrolyte sheet for solid oxide fuel cells according to claim 17, wherein the shortest distance is not shorter than 1 mm and not longer than 5 mm.

19. The method of producing an electrolyte sheet for solid oxide fuel cells according to claim 17, wherein the warpage height is not more than 100 μm.
